(19) United States
(12) Patent Application Publication
(10) Pub. No.: US 2018/0048811 A1
(43) Pub. Date: Feb. 15, 2018

(54) PATTERNED-ILLUMINATION SYSTEMS ADOPTING A COMPUTATIONAL ILLUMINATION

(71) Applicant: THE REGENTS OF THE UNIVERSITY OF CALIFORNIA, Oakland, CA (US)

(72) Inventors: Laura Waller, Berkeley, CA (US); Michael Chen, Irvine, CA (US); Li-Hao Yeh, Berkeley, CA (US)

(73) Assignee: THE REGENTS OF THE UNIVERSITY OF CALIFORNIA, Oakland, CA (US)

(21) Appl. No.: 15/659,379

(22) Filed: Jul. 25, 2017

Related U.S. Application Data
(63) Continuation of application No. PCT/US2016/015701, filed on Jan. 29, 2016.
(60) Provisional application No. 62/109,240, filed on Jan. 29, 2015.

(51) Int. Cl. H04N 5/232; H04N 5/235; G02B 21/36; H04N 5/225; G02B 21/06; G02B 27/58

(52) U.S. Cl. CPC H04N 5/23232; G02B 21/06; G02B 27/58; G02B 21/367; H04N 5/2256; H04N 5/2354

(57) ABSTRACT

A method and apparatus for increasing sample image resolution using patterned illumination. An array of optical emitters is selectively activated as a programmable light source, directed to a patterned mask which selectively changes amplitude or phase characteristics of optical energy received onto a sample. A sequence of images are captured of the sample, each being captured in response to a different spatial arrangement of optical outputs from the optical emitter array. These sample images are then post processed into a reconstructed image which has increased resolution over the separately collected images of the sample.

### CROSS-REFERENCE TO RELATED APPLICATIONS

This application is a 35 U.S.C. §111(a) continuation of PCT international application number PCT/US2016/015701 filed on Jan. 29, 2016, incorporated herein by reference in its entirety, which claims priority to, and the benefit of, U.S. provisional patent application Ser. No. 62/109,240 filed on Jan. 29, 2015, incorporated herein by reference in its entirety. Priority is claimed to each of the foregoing applications.

The above-referenced PCT international application was published as PCT International Publication No. WO 2016/123508 on Aug. 4, 2016, which publication is incorporated herein by reference in its entirety.

### STATEMENT REGARDING FEDERALLY SPONSORED RESEARCH OR DEVELOPMENT

This invention was made with Government support under 1351896 awarded by the National Science Foundation. The Government has certain rights in the invention.

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

### 1. Technical Field

The technology of this disclosure pertains generally to illumination during image capture, and more particularly to a method of computational illumination to increase image resolution without the need to mechanically switch the patterns of the patterned mask and/or the light source.

### 2. Background Discussion

In performing patterned illumination during image capture, industry efforts have focused on detection-side optical system design. For example, the filter or active elements were placed between the object and camera to code the collected data. In addition, a large part of significant imaging modalities requires shifting some specific patterns on the specimens' plane, including resolution enhancement in structured illumination microscopy, single-plane phase retrieval in X-ray, optical systems with patterned illumination, and high-resolution Ptychography. Commercial structured illumination microscopy is widely utilized to increase the resolution of the fluorescent image by a factor of two. Other variations of the structured illumination microscopy are active in academia, such as saturated structured illumination microscopy and total internal reflection fluorescent structured illumination microscopy, which can achieve greater than a factor of two improvement.

Phase retrieval at a single imaging plane has been proposed in which phase is to be recovered with several shifted patterns (usually a grating) illuminated on the sample and the images computationally combined to solve for phase. Similar methods are applied in Fourier Ptychography, where a diffused patterned illumination impinges on the object and is sequentially shifted in order to achieve super-resolution imaging (defined as resolution beyond the diffraction limit of the lenses used). However, all existing patterned illumination techniques either require mechanically moving parts at the object/mask plane or are placed between the light source and the specimen, or require insertion of a Spatial Light Modulator (SLM) as well as an additional imaging system in order to generate a displacement between the pattern and the object. Those mechanically moving devices are expensive and/or slow, while they are also very sensitive to error and tend to have poor repeatability.

Furthermore, the resolution of patterns formed via SLMs is restricted to the given pixel size and count, as well as the quality of the additional imaging system, which may become an obstacle for super-resolution applications, both in terms of resolution achieved and experimental complexity. A method to achieve pattern-shift by adjusting the incident angle of the X-ray via magnetic control on the direction of electron beam also has been proposed, however, it cannot be applied to optical imaging systems and it was merely developed to provide for differential phase contrast.

Accordingly, a need exists to overcome patterned illumination imaging shortcomings in regard to speed, mechanical complexity, and resolution. The present disclosure overcomes these shortcomings of previous technology while providing additional benefits.

### BRIEF SUMMARY

The disclosed technology overcomes a number of issues that significantly hinder the practical use of patterned illumination imaging modalities. In the presented technology an illumination pattern-shift can be achieved on the object plane by simply switching between illumination patterns with the use of simple computational illumination hardware without mechanically switching the patterns and/or the light source. It is also possible to shift the desired patterns by simply replacing the light source with the disclosed computational illumination hardware, which in a preferred embodiment is a lenseless system consisting of a significantly simpler optical setup. In addition, it is possible to smoothly shift a pattern at its maximum resolution without limitation of the illumination imaging system numerical aperture and/or other active devices.

By way of example, and not limitation, the present disclosure describes a new computational illumination architecture to be used for motion-free illumination pattern coding with any of multiple possible post-processing techniques that perform computational imaging, such as structured illumination microscopy (SIM) using speckle or grating pattern, which synthesize these structured fluorescent images to yield increased resolution, and structured illumination phase imaging. The method is realized by using a programmable light source (e.g., optical energy, or other source of electromagnetic energy) and a mask with an arbitrary phase or intensity pattern, placed before or after the sample in the imaging pathway. The desired pattern, comprising coded structured illumination, is projected on the object to achieve different horizontal displacements by changing the illumination angle of the light striking the pattern. The disclosed optical setup extends the use of LED arrays as a coded light source and controlling of the structured illumination with varying incident angle of light.

This simple hardware implementation enables any imaging technique relevant to pattern shifting by turning on different LEDs on the array. The disclosure describes how the illumination pattern, e.g., grating image, can be shifted by the presented method and demonstrates several different patterned-illumination imaging techniques using this setup, including phase retrieval, super-resolution imaging and a variation of Fourier Ptychography. In addition to the LED array setup, the same method can easily be applied to other computational illumination systems, such as a combination of single light source that is moving or patterned with Spatial Light Modulators (SLMs), deformable mirror devices (DMDs) or Liquid Crystal Displays (LCDs).

Numerous advantages and improvements are provided over prior technology, such as exemplified in the following. (a) Existing structured illumination techniques require expensive (greater than $1000) optical or mechanical devices, such as SLMs, DMDs, or piezo translation stages. With the disclosed computational illumination for pattern-shifting, only a low resolution programmable light source and a coded mask are needed to replace the lamp inside the microscope. This computational illumination hardware (e.g., an LED array) is very inexpensive at about $100 compared to existing systems and can be readily implemented into existing microscopes without extra hardware. In addition, the speed of the disclosed programmable illumination hardware (LED array) can be extremely fast and suitable for real-time imaging applications.

(b) The disclosed technique uses computational illumination to shift the pattern on the imaging plane without physical movement of any component, which is important especially for sensitive objects and small working distances. It does not suffer the hysteresis and repeatability problems of mechanical motion, nor is it polarization sensitive like many SLMs are. Phase patterned masks may be used in order to avoid any loss of photons through the system and make the light throughput better than competing methods.

(c) The function of shifting the illumination pattern can be incorporated in a patterned illumination imaging system by simply replacing the light source with the disclosed LED array or similar, without modifying the optical setup or using any additional lenses, and placing a patterned mask (phase or amplitude) in the illumination pathway (for example, a grating placed above the sample). The axial placement of the patterned mask need not be specified, which is convenient when designing a system that operates with large working distances.

(d) The resolution of the patterned mask is important when conducting structured illumination microscopy. The existing movable patterned mask generated by the light interference using SLM or DMD is focused through an imaging system, which imposes a resolution constraint (finite NA) on the patterned mask image. The disclosed technique does not re-image the pattern and shifts the mask pattern through propagation, which does not affect the resolution of the patterned mask image. Thus, a patterned mask with features much smaller than the resolution limit of the system can be used to achieve enhanced resolution imaging.

(e) Because the pattern shifting is achieved by moving the source instead of the pattern itself, and the source-to-pattern distance is generally much larger than the pattern-to-sample distance, the step size requirements for source stepping are much less stringent than they are for pattern stepping, significantly reducing the need for precise shifting. The shift and the pattern itself at the sample can be tuned by choosing the patterned mask-to-sample distance or source-to-pattern distance appropriately.

(f) Because the patterned mask sets the final resolution capabilities, a low-magnification imaging lens may be used on the detection side to achieve a very large field of view, while still reconstructing high resolution images through patterned illumination shifting in conjunction with computational algorithms.

(g) As compared to previous LED array-based imaging techniques, the disclosed system extends this hardware capability to any imaging modalities involving shifting of the illumination pattern. In one demonstration, the disclosed system is applied for Fourier Ptychography in which fluorescent samples are imaged, and for which traditional Fourier Ptychography is not capable of. This opens new applications for wide field-of-view high-resolution imaging in all modalities in which samples are fluorescently active (e.g., tagging or autofluorescence).

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is a schematic of a patterned illumination system according to an embodiment of the present disclosure.

FIG. 2A through FIG. 2D are images with the upper image of each showing the LED array pattern and a lower image from an optical microscope with shifting illumination patterns obtained according to an embodiment of the present disclosure.

FIG. 3A through FIG. 3E are images and plots of simulation results for pattern shifting utilizing an LED, with an original grating image in FIG. 3A, shifted grating image along x-axis in FIG. 3B, shifted grating image along y-axis in FIG. 3C, along with an x cross section of FIG. 3B seen in FIG. 3D, and a y cross section of FIG. 3C seen in FIG. 3E, as obtained according to an embodiment of the present disclosure.

FIG. 4A through FIG. 4K are images of simulation results of structured illumination microscopy utilizing an LED array to shift the patterns according to an embodiment of the present disclosure.

FIG. 5A through FIG. 5H are images of simulation results for phase retrieval using a grating and computational illumination according to an embodiment of the present disclosure.

FIG. 6A through FIG. 6G are images of simulation results for structured illumination microscopy using an LED array to shift the pattern according to an embodiment of the present disclosure.

### DETAILED DESCRIPTION

1. Illumination Pattern Shift Using An LED Array

The concept of the disclosed patterned-illumination system adopting computational illumination, is exemplified in the following illustrations.

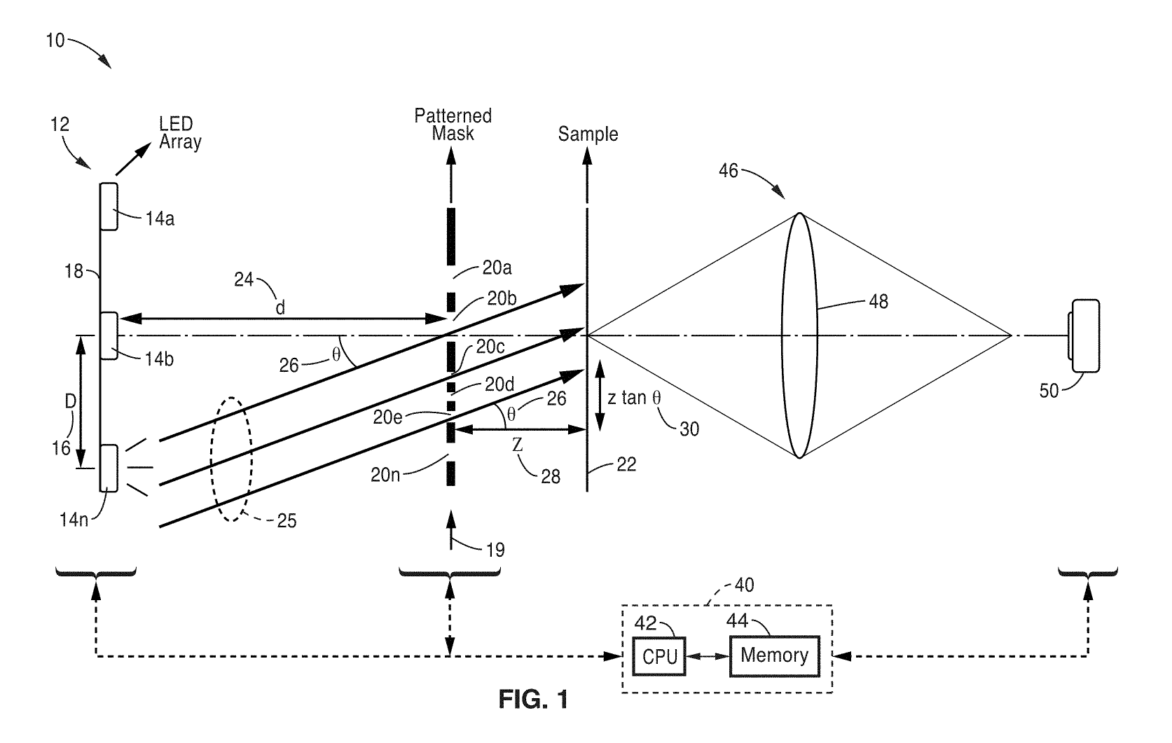

FIG. 1 illustrates an embodiment 10 of illumination pattern shifting using an array of optical elements, herein generally exemplified as a light emitting diode (LED) array 12, although other optical sources may be utilized without departing from the teachings of the disclosure. LED array 12 is shown with LEDs 14a, 14b, through 14n spaced a distance 16 (D) along a backplane 18. In this example LEDs 14a, 14b are shown non-active (not optically emitting) while LED 14n is actively outputting light. It will be appreciated that for the sake of simplicity of illustration, a single axis of LEDs is depicted, while in typical applications, the LED array would be implemented as a planar two-dimensional array.

The LED array 12 is placed sufficiently far away 24 (d) from the patterned mask 19 that each active LED 14n emits approximately a plane wave 25 from a unique angle 26 (θ), for example set by its spatial location in the case of an LED array. The plane wave 25 is seen striking/passing through the plane of patterned mask 19, which contains a plurality of optically transmissive apertures 20a, 20b, 20c, 20d, 20e, . . . 20n. Light which passes through the optical apertures (e.g., apertures formed as material voids, and/or transmissive material areas in a non-transmissive mask) impinge on sample 22 (target), which is seen at distance 28 (z) behind patterned mask 18. The sample is shown only by way of example as a planar target, while it will be appreciated that the techniques presented herein can be utilized with a wide range of shapes and structures. The light is seen displaced in relation to the angle 26 (θ) and the distance 28 (z), and amount of z tan θ 30. By displacing the patterned mask axially from the sample, changing the illumination angle shifts the illumination pattern laterally on the sample. This shift of the illumination pattern is thus performed using the light emitting element (e.g., LED) array without moving parts, so that one illuminates the patterned mask with different angles.

It should be appreciated that the patterned mask is shown in FIG. 1 is shown by way of example and not limitation. The disclosed approach is equally viable with other types of patterned masks, in particular amplitude masks which selectively transmit or reflect portions of their received energy (i.e., the electromagnetic spectrum at wavelengths from UHV RF through visible light and ultra-violet light spectrums), onto the sample, as well as phase masks which selectively alter the phase of the optical signal. For example, a reflective mask can be alternatively utilized which has a reflective pattern, on a non-reflective (or less reflective) background, so that energy is reflected from the pattern onto the sample.

The system is shown controlled by a controller circuit 40, which is exemplified as a computer processor 42 and memory 44, although various sequencing circuitry could be alternatively utilized. In the disclosed system, the 2D LED array (e.g., Adafruit® 32×32 array) is controlled by an computer processor and associated memory (e.g., Arduino® micro-controller). In addition, the patterned mask may also be controlled as desired according to certain embodiments of the present disclosure.

By way of example and not limitation, FIG. 1 also illustrates a form of imaging system that may be utilized in the system. An imaging system 46 is shown for collecting optical energy transmitted through, or alternatively reflected from, sample 22. This imaging system is exemplified as a lens 48, however, it may comprise any desired combination of lenses, mirrors, filters, and other optical elements for a given application. An image pickup device 50 (e.g., camera) is shown for capturing the optical energy collected by the imaging system and directed to image pickup device 50.

Some of the distinctions between the disclosed system and the current state of the art have been discussed. It should also be appreciated that the optical configuration of the disclosed system departs from existing systems in a number of additional ways. The light source in the disclosed system may comprise any array of programmable light emitting devices, such as SLM or laser array. A thick scattering media is not required, nor does the scattering media need to be upon, or closely proximal to, the sample. The scattering media does not need to provide memory effects. It should be noted that the use of thick scattering media, would allow the illumination to be only be shifted within about one degree to maintain the same structured pattern. The present disclosure relies upon a patterned mask that is sufficiently thin so as not to significantly limit angular displacement of the optical energies directed to the sample. It should also be noted that the present disclosure, does not require the scattering media to be attached to the sample, which is within the near field distance. The present disclosure does not have this limitation, and instead the sample may be placed an arbitrary distance from the thin mask.

It should be appreciated that the patterned mask may have a complex transmission function and be either an amplitude or phase mask (e.g., a phase grating), as long as it produces intensity variations at the sample plane. Phase masks produce intensity variations upon defocus and the amount of intensity variation will be important for sensitivity. For either phase or amplitude, the intensity pattern at the sample will shift laterally as the illumination angles vary.

The amount of the pattern shift for each angle of illumination can be related to the source position by using geometrical optics. Consider an LED array that is d away from a patterned mask. The lateral spacing between each LED is D and the patterned mask is axial distance z away from the sample. If the LED array produces light rays from an angle θ, the pattern shift at the sample in the x direction can be calculated as:

$$Δ x = z tan θ = \frac{zD}{d} \qquad ( 1 )$$

where tan θ=D/d. This indicates that an LED placed D away from center can generate a horizontal pattern shift of distance zD/d. Since the LED array is two-dimensional, the amount of pattern shift can be expressed fully as

$$( Δ x , Δ y ) = ( \frac{{zD}_{x}}{d} , \frac{{zD}_{y}}{d} ) \qquad ( 2 )$$

where Dₓ and D_{y} describe the displacement position of the LED from the center (optical axis).

Examining Eq. 2, it is seen that these beneficial very small shifts in the pattern at the sample are more easily achieved by coarser stepping at the source plane, since typically d>>z. Further, the sensitivity to errors in the shift step sizes will be significantly reduced by moving the stepping process to the source plane. In addition, if an LED array is used to shift the source, then the spacing between shifts can be very accurate and entirely repeatable, which is not true for mechanical shifting mechanisms.

To demonstrate the proposed pattern shifting methods experimentally, a programmable LED array was utilized as the light source in a conventional bright-field microscope (e.g., Nikon TE300). The 2D LED pattern was programmed with a micro-controller (e.g., Arduino), and by way of example, the spacing between each LED pair was 4 mm. A rectangular grating was then placed approximately 0.1 mm above the sample by inserting a cover glass between the grating and the sample to act as a spacer.

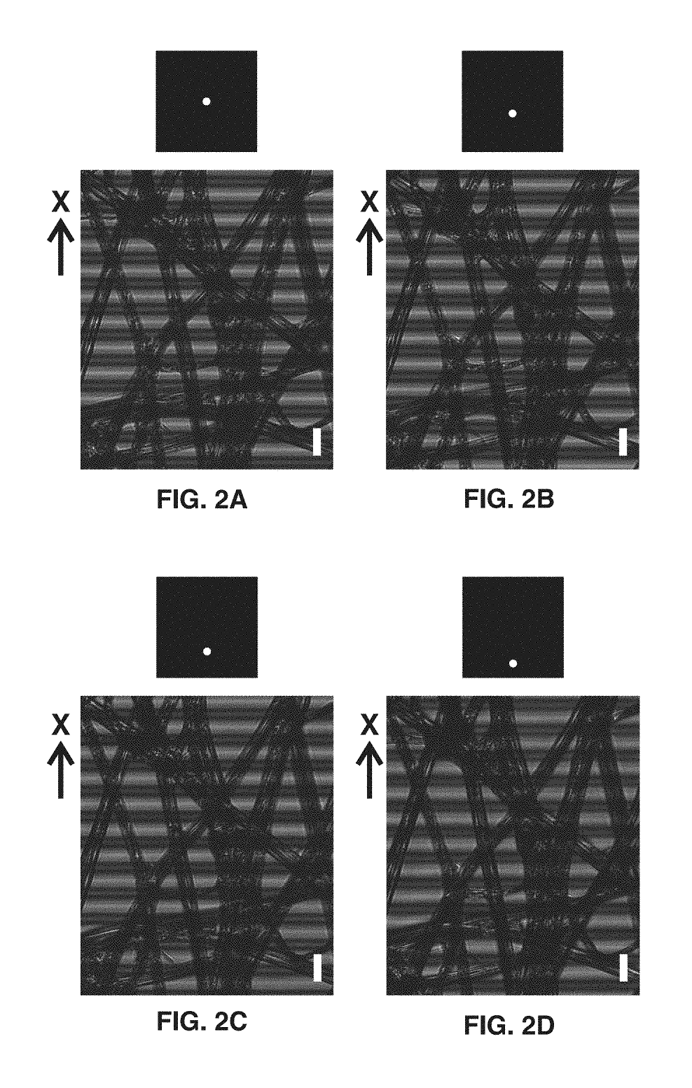

FIG. 2A through FIG. 2D depicts images of tissue paper fibers under an optical microscope shown with shifting illumination patterns using the disclosed method. In the top frames of each figure, the LED array pattern is shown. For the sake of illustration different LEDs are outputting light, shown from a center position in FIG. 2A through to an edge LED in FIG. 2D. The associated images are shown below each of these LED pattern images for each figure. The images in FIG. 2A through FIG. 2D were captured by a charge-coupled device (CCD) imager when focusing on the sample plane. The vertical length of the white stripes near the bottom corner is 25 μm.

As can be observed in FIG. 2A, the grating pattern is out of focus, so has diffraction near the edge of the black stripes, while the sample (tissue paper) is in focus. As the LED pattern is switched toward the negative x direction, the diffraction pattern of the grating is shifted in x direction, whereas the sample image stayed at the same position, as shown in FIG. 2B through FIG. 2D. Each time the pattern was shifted by a quarter of the pitch (π/2 shift), as expected when the distance between the grating and the LED array was approximately 64 mm. If the periodic pattern at the sample plane is desired to be the same as the grating above the sample, one can separate the gap between the grating and the sample planes to be multiples of the Talbot distance. Therefore, pattern shift can be achieved by using a computational illumination light source.

In addition, the illumination pattern shift was validated in 2D using an LED array and 2D patterned mask in simulation. Considering a sinusoidal grating pitch Λ=25 μm, LED central wavelength λ=643 nm, and z=2Λ²/λ, which is one Talbot distance away from the grating. The grating image at z=0 is the same as the image at one Talbot distance. By tuning the illumination angle on the grating plane, a Λ/2 pattern shift is generated along each lateral direction.

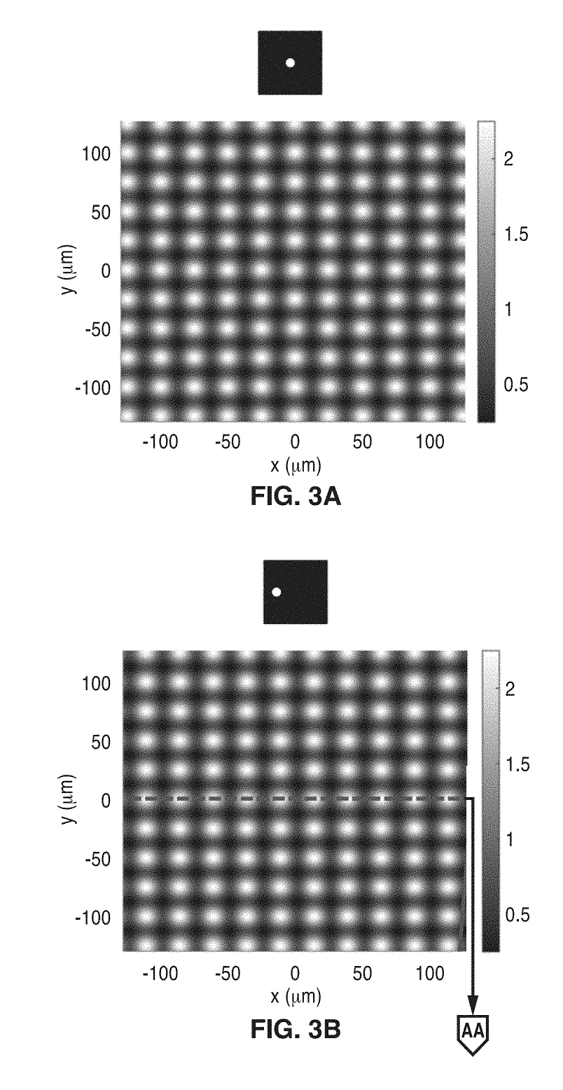

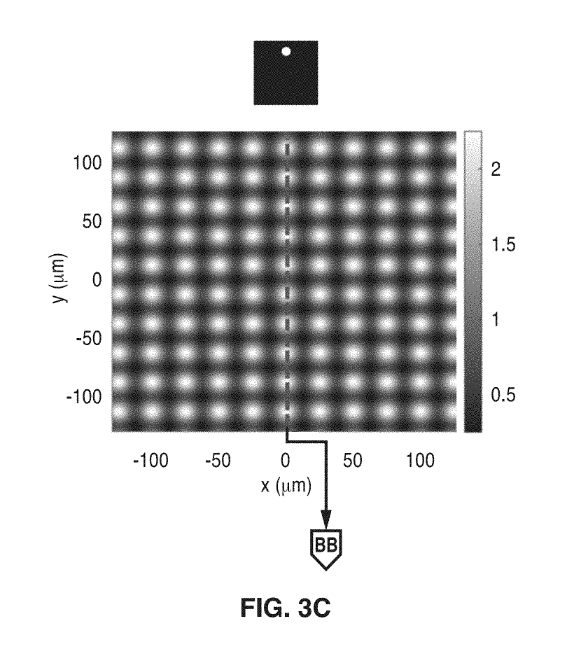

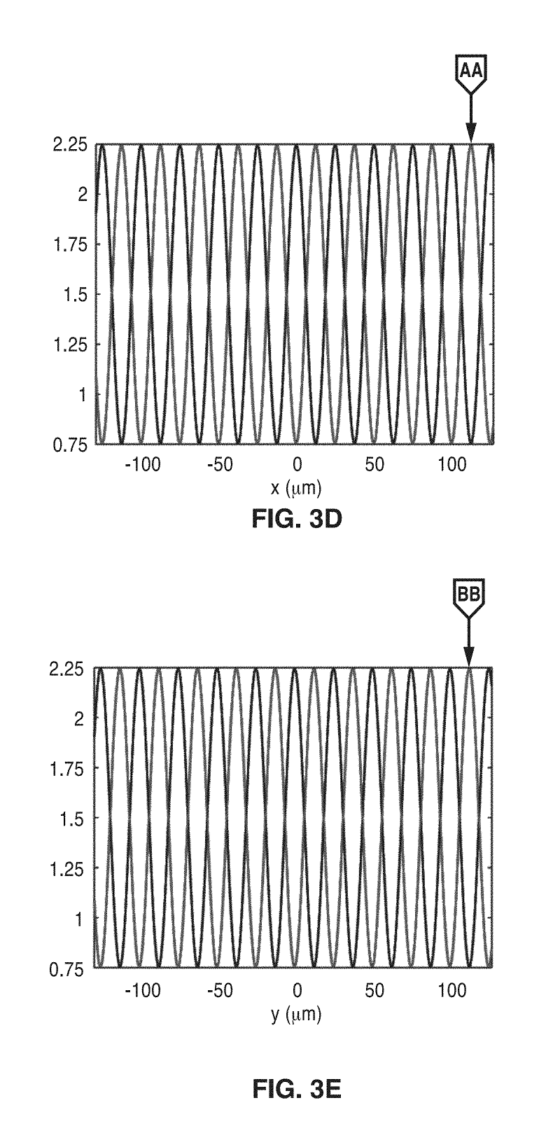

FIG. 3A through FIG. 3E shows the simulation results for pattern shift using a LED array. FIG. 3A depicts the original grating image. FIG. 3B and FIG. 3C show a Λ/2 pattern-shift in x and y direction, respectively. FIG. 3E and FIG. 3F depict the corresponding x and y cross-section of FIGS. 3B and 3C, respectively. Thus, 2D shifting can be achieved by 2D source patterning.

2. Application to Structured Illumination Microscopy

Structured illumination microscopy is a fluorescent imaging modality that can achieve super-resolution by patterned illumination. A sinusoidal illumination pattern is applied to modulate the fluorescent image as

M₁(x,y)=(I₁(x,y)·f(x,y))*h(x,y,z) (3)

where M₁ (x,y) is the 1-th image that is taken by the disclosed image system with imaging kernel h(x,y,z), and I₁ (x,y) is the structured illumination intensity, which can be expressed as

$${I}_{1} ( x , y ) = ( 1 + m cos ( \frac{2 π x}{Λ} + {φ}_{x 1} ) ) \cdot ( 1 + m cos ( \frac{2 π y}{Λ} + {φ}_{y 1} ) ) \qquad ( 4 )$$

The Fourier transform of M₁ (x,y) is further expressed as

$${\tilde{M}}_{1} ( {u}_{x} , {u}_{y} ) = ( {\tilde{I}}_{1} ( {u}_{x} , {u}_{y} ) * \tilde{f} ( {u}_{x} , {u}_{y} ) ) \cdot \tilde{h} ( {u}_{x} , {u}_{y} , z ) = \tilde{h} ( {u}_{x} , {u}_{y} , z ) \{ \tilde{f} ( {u}_{x} , {u}_{y} ) + \frac{m}{2} [ {e}^{i {φ}_{x 1}} \tilde{f} ( {u}_{x} - \frac{1}{Λ} , {u}_{y} ) + {e}^{- i {φ}_{x 1}} \tilde{f} ( {u}_{x} + \frac{1}{Λ} , {u}_{y} ) + {e}^{i {φ}_{y 1}} \tilde{f} ( {u}_{x} , {u}_{y} - \frac{1}{Λ} ) + {e}^{- i {φ}_{y 1}} \tilde{f} ( {u}_{x} , {u}_{y} + \frac{1}{Λ} ) ] + \frac{{m}^{2}}{4} [ {e}^{i ( {φ}_{x 1} + {φ}_{y 1} )} \tilde{f} ( {u}_{x} - \frac{1}{Λ} , {u}_{y} - \frac{1}{Λ} ) + {e}^{i ( {φ}_{x 1} - {φ}_{y 1} )} \tilde{f} ( {u}_{x} - \frac{1}{Λ} , {u}_{y} + \frac{1}{Λ} ) + {e}^{i ( {φ}_{x 1} - {φ}_{y 1} )} \tilde{f} ( {u}_{x} + \frac{1}{Λ} , {u}_{y} - \frac{1}{Λ} ) + {e}^{- i ( {φ}_{x 1} + {φ}_{y 1} )} \tilde{f} ( {u}_{x} + \frac{1}{Λ} , {u}_{y} + \frac{1}{Λ} ) ] \} \qquad ( 5 )$$

The measurement of the modulated image contains the overlapping of both the high-frequency and the low-frequency spatial components. Images captured with shifted illumination patterns are thus necessary to separate the overlapping information in the Fourier domain. In this case, nine pictures with different phase shifts are used to solve for the high-resolution image.

The image I₁ (x,y) is usually generated by a grating or SLM-controlled interference pattern imaged onto the sample. The pattern shift, φₓ₁ and φ_{y1}, is achieved by mechanically moving the grating or tuning the interference phase by SLM. In our approach, the pattern shift is achieved by turning on different LEDs on the array, which is a much faster, simpler and less costly technique for implementing structured illumination microscopy.

To demonstrate, structured illumination microscopy was simulated using a shifted pattern generated by an LED array with central wavelength λ=643 nm. The grating, with pitch Λ=1.25 μm is a talbot distance (z=2Λ²/λ) was positioned in front of the sample.

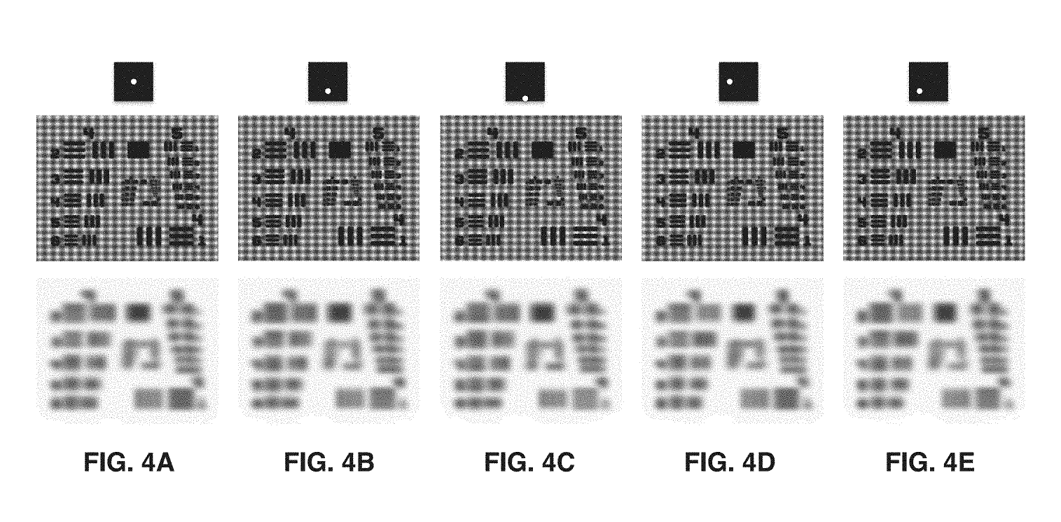

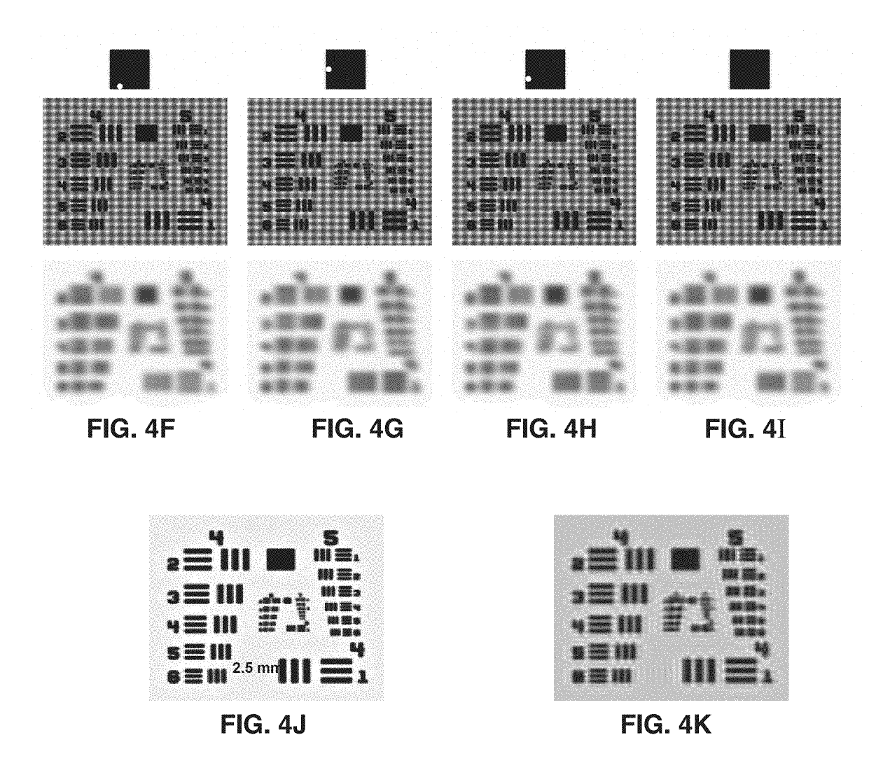

FIG. 4A through FIG. 4K illustrate simulation results of structured illumination microscopy using an LED array to shift the pattern. Each of the nine figures of FIG. 4A through FIG. 41 depicts an LED pattern above, a sample plane in the middle image illuminated by the LED pattern above, and in the lower image the corresponding image which was collected by the image system (NA=0.25). FIG. 4J depicts the sample itself, with FIG. 4K showing a reconstructed image, which can be seen to provide significant clarity and resolution benefits over each of the separate nine images collected, which each appear similarly “blurry”.

Since the frequency component of the illumination is so high that the image system utilized with NA=0.25 can barely resolve it, the collected images are blurred. However, the blurred images still carry information from the higher frequency components and so the resolution can be recovered computationally. FIG. 4K is the reconstructed image from the lower image seen in FIG. 4A through FIG. 41. Compared to the original sample of FIG. 4J, the reconstructed image can achieve resolution down to approximately 0.6 μm, which is the two-fold resolution enhancement predicted by structured illumination theory. The LED array provides a fast alternative mechanism for implementing structured illumination.

3. Applying This Technology To Phase Retrieval

Phase retrieval by coded illumination can measure the phase gradient of a complex object by adding a spatially modulated illumination. The relationship between the phase gradient (∇φ), defocused intensities of the phase object with (I_{illu&obj}) and without (I_{obj}) pattern, and the intensity of the pattern (Iᵢₗₗᵤ) is given by the following:

$${I}_{illu} ( x , y ; 0 ) \cdot ∇ φ ( x , y ; 0 ) = - \frac{2 π}{λ Δ z} ( {I}_{illu \& obj} ( x , y ; Δ z ) - {I}_{obj} ( x , y ; Δ z ) \times {I}_{illu} ( x , y ; Δ z ) ) \qquad ( 6 )$$

where λ is the wavelength of incident light and Δz represents a small defocus plane behind the object. Some information is missing due to the existence of zero gradient in the illumination pattern at certain locations. Therefore, images with shifted patterns are also captured to recover the entire phase gradient profile at the full resolution of the imaging system. This can be achieved by mechanically shifting a physical pattern, or generating different patterns with an external light modulator (e.g., DMD/SLM). The object is often accidentally moved if the pattern is physically shifted, and sub-fringe steps are required which demand extremely precise motion stages, which are expensive and slow. Moreover, in addition to complicated alignment, the numerical aperture of the imaging system limits the resolution of pattern generated from DMD or SLM. However, in utilizing the disclosed approach, a high-resolution illumination pattern can be shifted smoothly without sophisticated optical systems, and there is no limit to the number of illumination lenses or the resolution achievable.

To demonstrate phase retrieval using the proposed computational illumination, the same setup is described as before (by way of example and not limitation) and images are captured at a distance Δz (50 μm in this simulation) behind the sample plane. The illumination source is again a programmable LED array. The parameters, including LED spacing (D), distance between LED array and grating (d), grating pitch (Λ), and distance between grating and sample (z) are selected such that the spacing between LEDs in the array corresponds to an angle difference in the illumination that causes a quarter pitch shift of the grating pattern at the sample plane for each LED step.

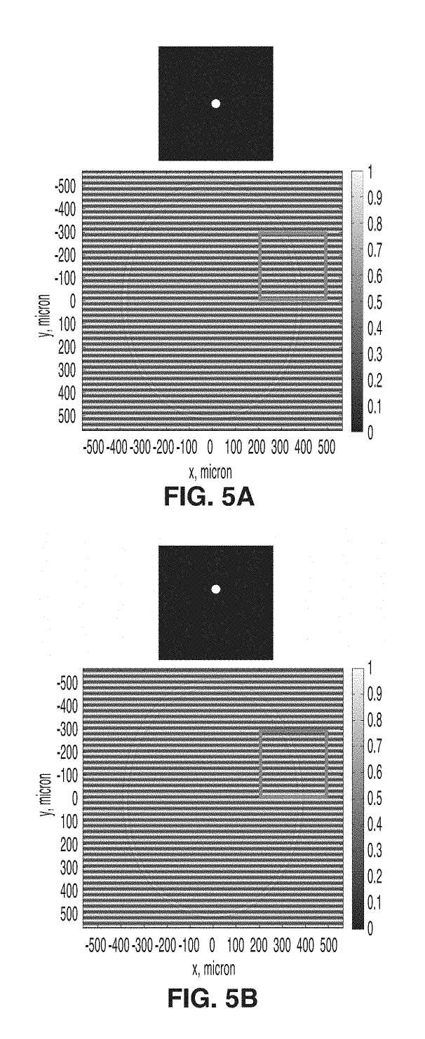

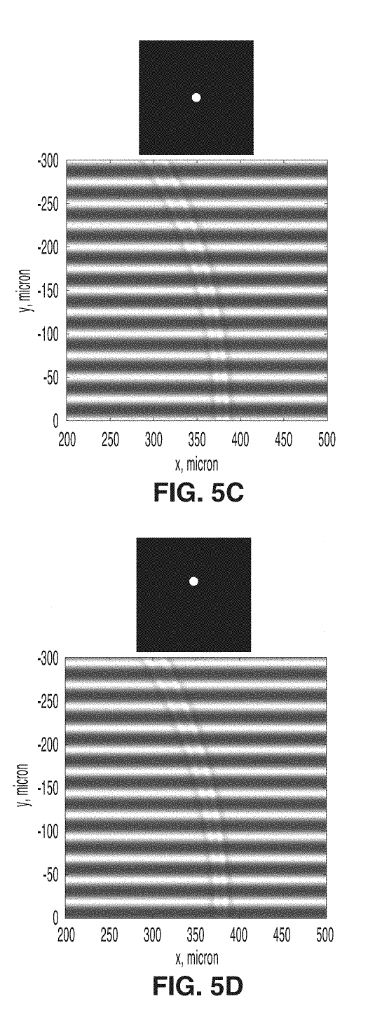

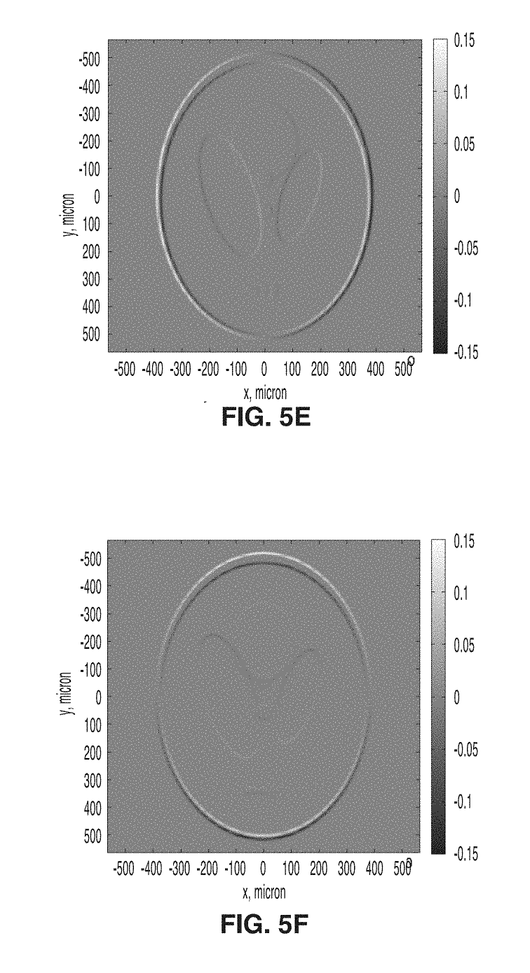

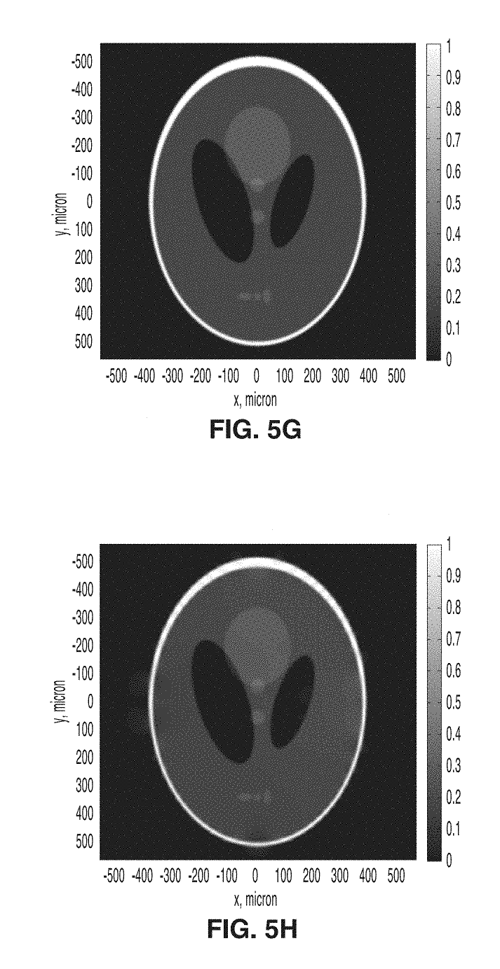

FIG. 5A through FIG. 5H illustrate simulation results for phase retrieval using a grating and computational illumination.

In FIG. 5A a simulated diffraction image is seen at the defocused plane with illumination by the central LED, while the image in FIG. 5B shows the defocused image with an illumination of the adjacent LED in the y direction. The image resulting from an oblique incident angle in FIG. 5B is computationally shifted back Δz tan θ_{y} in order to get the same results as directly shifting the grating itself.

In FIG. 5C and FIG. 5D, zoomed profiles are seen for the corresponding illumination in the region of the rectangular boxes seen in FIG. 5A and FIG. 5B. It can be clearly seen that the diffracted grating pattern in FIG. 5D shifts nearly a quarter pitch toward the downside, which agrees with the description of the present technology.

Analogous results are achieved if the 1D grating pattern is rotated by 90°, in which case the phase information is obtained along the x direction. Therefore, by using the simulated images in FIG. 5A through FIG. 5D, insofar as the defocused image of the sample with a normal incident light (without grating) is available or can be computed, the gradient can be reconstructed of phase distribution along x(∇φₓ) and y(∇φ_{y}.

In FIG. 5E and FIG. 5F phase gradient results are utilized as per the present disclosure to evaluate the quantitative phase of the test sample by a FFT-based Poisson solver.

In FIG. 5G and FIG. 5H phase information is shown. In FIG. 5G actual phase distribution is shown. In FIG. 5H the recovered phase profile is shown using the simulated defocused images. The retrieved phase result is equal to that produced by physically shifting the grating, which means that the present disclosure provides a relatively simple, fast, readily implemented and inexpensive mechanism for coding aperture illumination for phase retrieval.

4. Application to Fluorescent Imaging Via Fourier Ptychography

Fourier ptychography is an iterative algorithm for coherent imaging to extend the spatial resolution using data from angular-illuminated samples, which can be applied to incoherent imaging (e.g., fluorescent imaging).

Consider the case in which a fluorescent image is formed according to the distribution of fluorescent beads. This distribution can be modulated by an unknown illumination pattern (e.g., a speckle pattern) and be collected by the imaging system as

Iₙ(x)=(I_{f}(x)·P(x−xₙ))*h(x) (7)

where Iₙ(x) is the n-th collected intensity on the CCD, I_{f} (x) is the fluorescent intensity (distribution) modulated by the unknown illumination P(x) shifted by xₙ, and h(x) is the kernel of the image system.

The fluorescent intensity, I_{f}, and unknown illumination pattern, P, then can be solved by the iterative algorithms summarized below:

(a) Initially guess a fluorescent image and an unknown illumination pattern as I_{obj} and Pᵤ;
(b) Create a n-th estimated intensity as Iₜₙ=I_{obj}˜Pᵤ.

Follow the modified updating equations below for each collected data until the estimated I_{obj} and Pᵤ converges:

$$\begin{matrix} {\tilde{I}}_{tn}^{update} ( u ) = {\tilde{I}}_{tn} ( u ) + \frac{\vert \tilde{h} ( u ) \vert}{{\vert \tilde{h} ( u ) \vert}_{max}} \cdot \frac{{\tilde{h} ( u )}^{*} \cdot ( {\tilde{I}}_{n} ( u ) - \tilde{h} ( u ) \cdot {\tilde{I}}_{tn} ( u ) )}{{\vert \tilde{h} ( u ) \vert}^{2} + {δ}_{1}} & ( 8 ) \\ {I}_{obj}^{update} ( x ) = {I}_{obj} ( x ) + \frac{\vert {P}_{u} ( x - {x}_{n} ) \vert}{{\vert {P}_{u} ( x - {x}_{n} ) \vert}_{max}} \cdot \frac{{{P}_{u} ( x - {x}_{n} )}^{*} \cdot ( {I}_{tn}^{update} ( x ) - {I}_{tn} ( x ) )}{{\vert {P}_{u} ( x - {x}_{n} ) \vert}^{2} + {δ}_{2}} & \\ {P}_{u}^{update} ( x - {x}_{n} ) = {P}_{u} ( x - {x}_{n} ) + \frac{\vert {I}_{obj} ( x ) \vert}{{\vert {I}_{obj} ( x ) \vert}_{max}} \cdot \frac{{{I}_{obj} ( x )}^{*} \cdot ( {I}_{tn}^{update} ( x ) - {I}_{tn} ( x ) )}{{\vert {I}_{obj} ( x ) \vert}^{2} + {δ}_{3}} & \end{matrix}$$

where Ã(u)=F{A(x)}, δ₁, δ₂, and δ₃ are different regularization numbers for different updating equations.

For this method, the illumination pattern is shifted mechanically during the data-collecting process, which requires not an insignificant amount of time. Yet, in implementing the system according to the present disclosure the LED array is used to replace the mechanical pattern-shift with the angular-illuminated pattern shift, which operates significantly faster.

To demonstrate, a fluorescent image is simulated being modulated by a speckle pattern with the spreading angle 20° (corresponds to NAₛ=0.17) and collected by the imaging system with NAᵢ=0.1. The extended NA of this system using this approach should be NAₛ+NAᵢ=0.27.

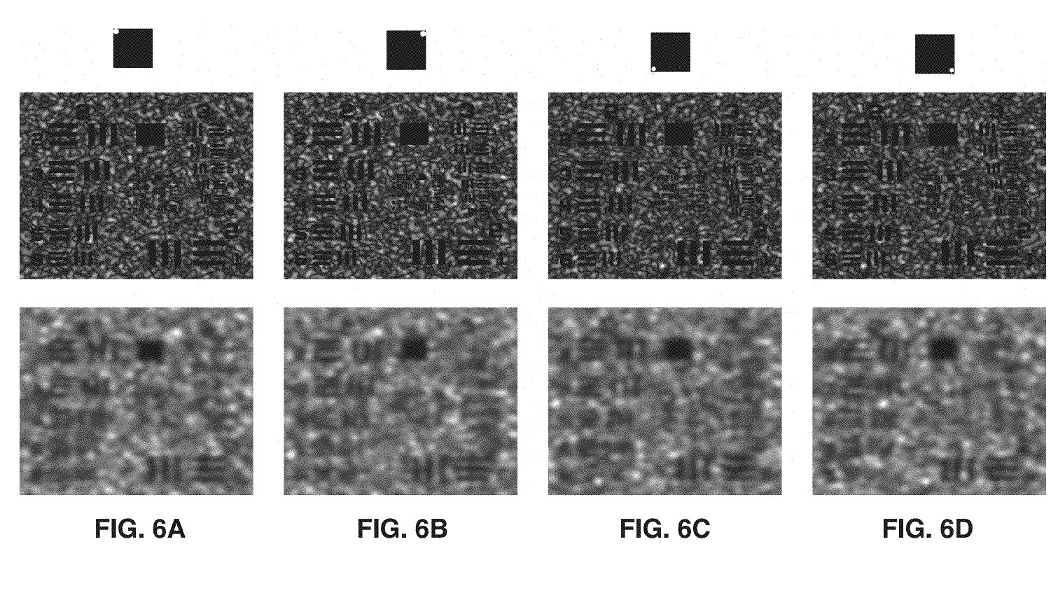

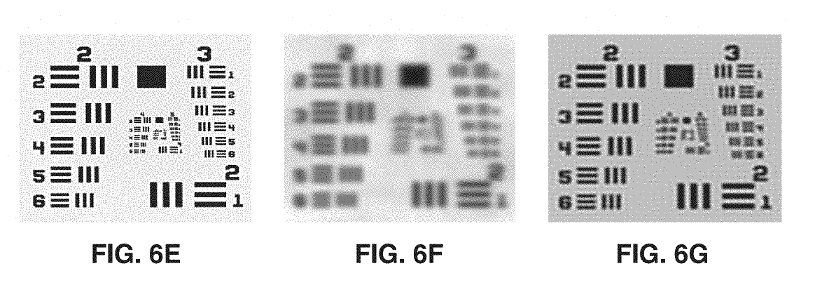

FIG. 6A through FIG. 6G illustrate simulation results of structured illumination microscopy using an LED array to shift the pattern. In an upper image in each of FIG. 6A through 6D an LED pattern (top) is shown, below which (middle) is shown a sample plane scanned along the LED pattern, below which (lower) is seen a corresponding image collected by the image system (NA=0.1).

Thus, the lower image in figures FIG. 6A through FIG. 6D show the sample image modulated by shifted speckle pattern via changing the LED pattern. Since this method requires multiple pictures with small stepping of the speckle pattern in each direction, the LED array is turned on one by one sequentially to project shifted speckle patterns onto the sample plane.

FIG. 6E, FIG. 6F, and FIG. 6G show, respectively, the original sample, image of the original sample through the image system with NA=0.1, and the reconstructed image with expected NA=0.27. The resolution of the reconstructed image reaches around 1 μm, which corresponds to the NA of the present disclosure as discussed in a previous section.

5. Possible Hardware Variations

The same illumination pattern shift can be equally realized by combining other computational illumination hardware and the desired patterned mask. SLMs and DMDs can also control the incident angle of the light by changing the transmission or reflection pattern on the hardware, or other angle scanning methods may be used. In addition to turning on a single LED, a one-dimensional pattern shift can be achieved by turning on a subset of multiple LEDs on the array to reduce the exposure time and thus data acquisition time via multiplexing techniques.

The enhancements described in the presented technology can be readily implemented within various light array sources and computational systems. It should also be appreciated that controlling a light array and performing processing of imaging results are preferably implemented to include one or more computer processor devices (e.g., CPU, microprocessor, microcontroller, computer enabled ASIC, etc.) and associated memory storing instructions (e.g., RAM, DRAM, NVRAM, FLASH, computer readable media, etc.) whereby programming (instructions) stored in the memory are executed on the processor to perform the steps of the various process methods described herein.

Computer and memory devices were depicted in FIG. 1 for the sake of simplicity of illustration. One of ordinary skill in the art recognizes that a wide range of control circuits, programmable arrays, and/or computer processors may be utilized for carrying out the steps of light array encoding and image processing operations according to the present disclosure. The presented technology is non-limiting with regard to memory and computer-readable media, insofar as these are non-transitory, and thus not constituting a transitory electronic signal.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, computer processor, central processing unit (CPU), and computer are used synonymously to denote a device capable of executing the instructions and communicating with input/output interfaces and/or peripheral devices, and that the terms processor, computer processor, CPU, and computer are intended to encompass single or multiple devices, single core and multicore devices, and variations thereof.

From the description herein, it will be appreciated that that the present disclosure encompasses multiple embodiments which include, but are not limited to, the following:

1. An apparatus for performing patterned illumination utilizing computational illumination during image capture, comprising: (a) an array of optical emitters configured for being selectively activated as a programmable light source; (b) a patterned mask; (c) wherein optical emitters in said array of optical emitters are configured for illuminating a sample in response to optical energy transmitted through, or reflected from, said patterned mask; (d) an image capture device configured for collecting images of the sample; (e) a computer processor configured for controlling said array of optical emitters and for performing image processing; and (f) a non-transitory computer-readable memory storing instructions executable by the computer processor; and (g) wherein said instructions, when executed by the computer processor, perform steps comprising: (g)(i) selecting a first optical output pattern from said array of optical emitters; (g)(ii) collecting a first image of the sample on said image capture device; (g)(iii) selecting a subsequent optical output pattern, as a one dimensional pattern shifting illumination angle to the sample, from said array of optical emitters; (g)(iv) collecting a subsequent image of the sample; (g)(v) repeating steps (iii) to (iv) as desired; and (g)(vi) post processing of said first image and said subsequent images into a reconstructed image having increased resolution over each of said collected images.

2. The apparatus of any preceding embodiment, wherein said array of optical emitters comprises an array of light emitting diodes (LEDs).

3. The apparatus of any preceding embodiment, wherein said array of optical emitters comprises a multi-dimensional array of optical emitters.

4. The apparatus of any preceding embodiment, wherein said patterned mask is configured for transmitting energy through portions of said patterned mask onto the sample.

5. The apparatus of any preceding embodiment, wherein said patterned mask is configured for reflecting energy from portions of said patterned mask onto the sample.

6. The apparatus of any preceding embodiment, wherein said patterned mask is configured for altering phase of optical energy from portions of said patterned mask onto the sample.

7. The apparatus of any preceding embodiment, further comprising an imaging system coupled to said image capture device, and configured for directing optical energies from the sample to said image capture device.

8. The apparatus of any preceding embodiment, wherein said increased resolution is achieved without switching the pattern of the patterned mask.

9. The apparatus of any preceding embodiment, wherein said patterned illumination increases image resolution without mechanically switching the pattern of the patterned mask or mechanically switching a light source.

10. The apparatus of any preceding embodiment, wherein said increased resolution is up to a factor of two.

11. A method of performing patterned illumination utilizing computational illumination during image capture, comprising: (a) positioning an array of optical emitters for directing light through a patterned mask illuminating a sample in response to optical energy transmitting through, or reflecting from, the patterned mask; (b) positioning an image capture device for collecting images from the sample; (c) selecting an optical output pattern from the array of optical emitters, in response to commands from a control circuit, and collecting at least one image of the sample; (d) selecting subsequent optical output patterns, as one dimensional pattern shifting illumination angles to the sample, from the array of optical emitters, and collecting subsequent images of the sample; and (e) post processing of the collected images into a reconstructed image having increased resolution over each of said collected images, considered separately.

12. The method of any preceding embodiment, further comprising forming the array of optical emitters from an array of light emitting diodes (LEDs).

13. The method of any preceding embodiment, wherein the array of optical emitters is comprising a multi-dimensional array of optical emitters.

14. The method of any preceding embodiment, wherein the patterned mask is configured for transmitting energy through portions of the patterned mask onto the sample.

15. The method of any preceding embodiment, wherein the patterned mask is configured for reflecting energy from portions of the patterned mask onto the sample.

16. The method of any preceding embodiment, wherein the patterned mask is configured for altering phase of optical energy from portions of the patterned mask onto the sample.

17. The method of any preceding embodiment, further comprising performing imaging to optically manipulate and direct optical energies from the sample to the image capture device.

18. The method of any preceding embodiment, wherein increased resolution is achieved without switching the pattern of the patterned mask.

19. The method of any preceding embodiment, wherein the patterned illumination increases image resolution without mechanically switching the pattern of the patterned mask or mechanically switching a light source.

20. The method of any preceding embodiment, wherein the increased resolution is up to a factor of two.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for performing patterned illumination utilizing computational illumination during image capture, comprising:
(a) an array of optical emitters configured for being selectively activated as a programmable light source;
(b) a patterned mask;
(c) wherein optical emitters in said array of optical emitters are configured for illuminating a sample in response to optical energy transmitted through, or reflected from, said patterned mask;
(d) an image capture device configured for collecting images of the sample;
(e) a computer processor configured for controlling said array of optical emitters and for performing image processing; and
(f) a non-transitory computer-readable memory storing instructions executable by the computer processor; and
(g) wherein said instructions, when executed by the computer processor, perform steps comprising:
(i) selecting a first optical output pattern from said array of optical emitters;
(ii) collecting a first image of the sample on said image capture device;
(iii) selecting a subsequent optical output pattern, as a one dimensional pattern shifting illumination angle to the sample, from said array of optical emitters;
(iv) collecting a subsequent image of the sample;
(v) repeating steps (iii) to (iv) as desired; and
(vi) post processing of said first image and said subsequent images into a reconstructed image having increased resolution over each of said collected images.

2. The apparatus of claim 1, wherein said array of optical emitters comprises an array of light emitting diodes (LEDs).

3. The apparatus of claim 1, wherein said array of optical emitters comprises a multi-dimensional array of optical emitters.

4. The apparatus of claim 1, wherein said patterned mask is configured for transmitting energy through portions of said patterned mask onto the sample.

5. The apparatus of claim 1, wherein said patterned mask is configured for reflecting energy from portions of said patterned mask onto the sample.

6. The apparatus of claim 1, wherein said patterned mask is configured for altering phase of optical energy from portions of said patterned mask onto the sample.

7. The apparatus of claim 1, further comprising an imaging system coupled to said image capture device, and configured for directing optical energies from the sample to said image capture device.

8. The apparatus of claim 1, wherein said increased resolution is achieved without switching the pattern of the patterned mask.

9. The apparatus of claim 1, wherein said patterned illumination increases image resolution without mechanically switching the pattern of the patterned mask or mechanically switching a light source.

10. The apparatus of claim 1, wherein said increased resolution is up to a factor of two.

11. A method of performing patterned illumination utilizing computational illumination during image capture, comprising:
(a) positioning an array of optical emitters for directing light through a patterned mask illuminating a sample in response to optical energy transmitting through, or reflecting from, the patterned mask;
(b) positioning an image capture device for collecting images from the sample;
(c) selecting an optical output pattern from the array of optical emitters, in response to commands from a control circuit, and collecting at least one image of the sample;
(d) selecting subsequent optical output patterns, as one dimensional pattern shifting illumination angles to the sample, from the array of optical emitters, and collecting subsequent images of the sample; and
(e) post processing of the collected images into a reconstructed image having increased resolution over each of said collected images, considered separately.

12. The method of claim 11, further comprising forming the array of optical emitters from an array of light emitting diodes (LEDs).

13. The method of claim 11, wherein the array of optical emitters is comprising a multi-dimensional array of optical emitters.

14. The method of claim 11, wherein the patterned mask is configured for transmitting energy through portions of the patterned mask onto the sample.

15. The method of claim 11, wherein the patterned mask is configured for reflecting energy from portions of the patterned mask onto the sample.

16. The method of claim 11, wherein the patterned mask is configured for altering phase of optical energy from portions of the patterned mask onto the sample.

17. The method of claim 11, further comprising performing imaging to optically manipulate and direct optical energies from the sample to the image capture device.

18. The method of claim 11, wherein increased resolution is achieved without switching the pattern of the patterned mask.

19. The method of claim 11, wherein the patterned illumination increases image resolution without mechanically switching the pattern of the patterned mask or mechanically switching a light source.

20. The method of claim 11, wherein the increased resolution is up to a factor of two.
